(19) United States
(12) Patent Application Publication
(10) Pub. No.: US 2005/0132934 A1
(43) Pub. Date: Jun. 23, 2005

(54) Method for the integrated production of casts and mortars and of gravel substitute

(76) Inventor: Eckehard Maruhn, Hamburg (DE)

Correspondence Address: BACHMAN & LAPOINTE, P.C., 900 CHAPEL STREET, SUITE 1201, NEW HAVEN, CT, 06510, US

(21) Appl. No.: 10/498,282

(22) PCT Filed: Dec. 5, 2002
(86) PCT No.: PCT/IB02/05747

(30) Foreign Application Priority Data
Dec. 5, 2001 (AT) GM 931/2001

(51) Int. Cl. C04B 14/48; C04B 16/00; B32B 15/02; C04B 28/08; B32B 21/02; C04B 7/14; B32B 17/02; C04B 7/00; C04B 5/00; C04B 18/18; C04B 22/04; B32B 27/02; B32B 23/02; B32B 19/00; B32B 9/00; B32B 5/16; C04B 14/00

(52) U.S. Cl. 106/789; 106/641; 106/697; 428/404; 428/403; 106/816

(57) ABSTRACT

A method for the integrated production of casts and mortars on the basis of hydraulic binders and in gravel substitute. In a first step, slag is subdivided into a first and a second fraction having different average grain sizes. The first fraction having a larger average grain size is size-reduced and returned to the slag, and the iron-containing components and optionally plastics and paper are removed from the second fraction having a smaller average grain size. In a second step, the second fraction is subdivided into superfines and gravel, the superfines being used, after optionally removing non-iron metals, for producing hydraulic binders. In a third step, the hydraulic binders are used with superfines and tectosilicates for producing casts and mortars, and with gravel to produce a gravel substitute.

### BACKGROUND OF THE INVENTION

The invention relates to a method for the integrated production of casts and mortars and gravel substitute based on hydraulic binders and also to casts and mortars and to gravel substitute based on hydraulic binders.

The starting material used is slag from garbage incineration plants and also scoria and metallurgical slag. This comprises the solid, incombustible residues which arise during incineration in industrial furnaces or garbage incineration plants.

In the case of garbage incineration, slag weighs about 35% of the original weight of the garbage. Typical household garbage usually comprises, in percent by weight, 59-69% silicon oxide, 4.9-7.8% iron oxide, 5.1-6.3% aluminum oxide and 8.3-10.3% lime and is therefore suitable for producing an inorganic hydraulic binder for concrete-like curing compounds, casts and mortars. Besides the iron-containing components, garbage incineration slag also comprises considerably smaller fractions of non-iron metals such as copper, nickel, lead, zinc or tin in varying amounts.

Ironworks slags may be broken down into blast furnace slags and scoriae, where blast furnace slags arise during the production of pig irons in the blast furnace and scoriae arise during the production of steel in converters, in electric furnaces and in Siemens-Martin furnaces. Metalworks slags are formed during the production of non-iron metals. In accordance with the current prior art, around 250 kg of blast furnace slag are produced per ton of pig iron and around 120 kg of scoria are produced per ton of crude steel. Large amounts of slag are thus produced which could be reused. Blast furnace slag is essentially used as grit and ballast in road building. Scoriae are used in particular in the building trade, in particular in road building and hydraulic engineering.

Blast furnace slag and scoria differ in terms of their chemical composition; however, on account of their main constituents calcium oxide, silicon dioxide, aluminum oxide and iron oxide, they are both suitable for producing hydraulic binders.

Moreover, it has been found that slag from garbage incineration plants and scoria and metallurgical slag are also suitable as a starting material for the production of casts and mortars and also as the basic body of gravel substitute. The object of the invention is therefore to use these properties of slag in an integrated method such that slag from garbage incineration plants and scoria and metallurgical slag is used to produce hydraulic binders, and then hydraulic binders are used for the further treatment of the slag in order ultimately to produce not only casts and mortars but also gravel substitute.

### SUMMARY OF THE INVENTION

The foregoing object is achieved in accordance with the present invention by providing a method wherein, in a first method step, slag is divided into a first and a second fraction with different mean particle sizes, wherein the first fraction having a greater mean particle size is comminuted and returned to the slag, and iron-containing components and optionally plastics and paper are removed from the second fraction having a smaller mean particle size. In a second method step the second fraction is subdivided into superfines having the smallest mean particle size and gravel having a greater mean particle size, wherein the superfines are used, after optionally removing non-iron metals, to produce hydraulic binders. In a third method step, these hydraulic binders are finally used with the superfines, tectosilicates and optionally aluminum-containing components to produce casts and mortars, and with the gravel, after optionally removing non-iron metals, to produce gravel substitute.

In accordance with the present invention the slag may come from garbage incineration plants, scoria or metallurgical slag. The particle size of the first fraction is greater than 32 mm and those of the second fraction are less than 32 mm. The particle size of the superfines are less than 4 mm and those of the gravel are greater than 4 mm. In a preferred embodiment the gravel substitute is produced by coating the gravel with hydraulic binders.

In accordance with the present invention, the casts and mortars based on hydraulic binders comprise from 55 to 65%, preferably 60% garbage incineration slag, metallurgical slag and scoria in any desired mixing ratio but having particle sizes of less than 4 mm; 30 to 40%, preferably 35%, hydraulic binders; 4 to 6%, preferably 5%, tectosilicates; and optionally 3-5% aluminum powder having particle sizes of less than 0.06 mm.

In accordance with a further feature of the present invention, a gravel substitute consists of a basic body made of slag coated with a hydraulic binder wherein the hydraulic binder is produced on the basis of slag from garbage incineration plants, scoria or metallurgical slag. The slag has a particle size of between 4 to 32 mm.

### BRIEF DESCRIPTION OF THE DRAWINGS

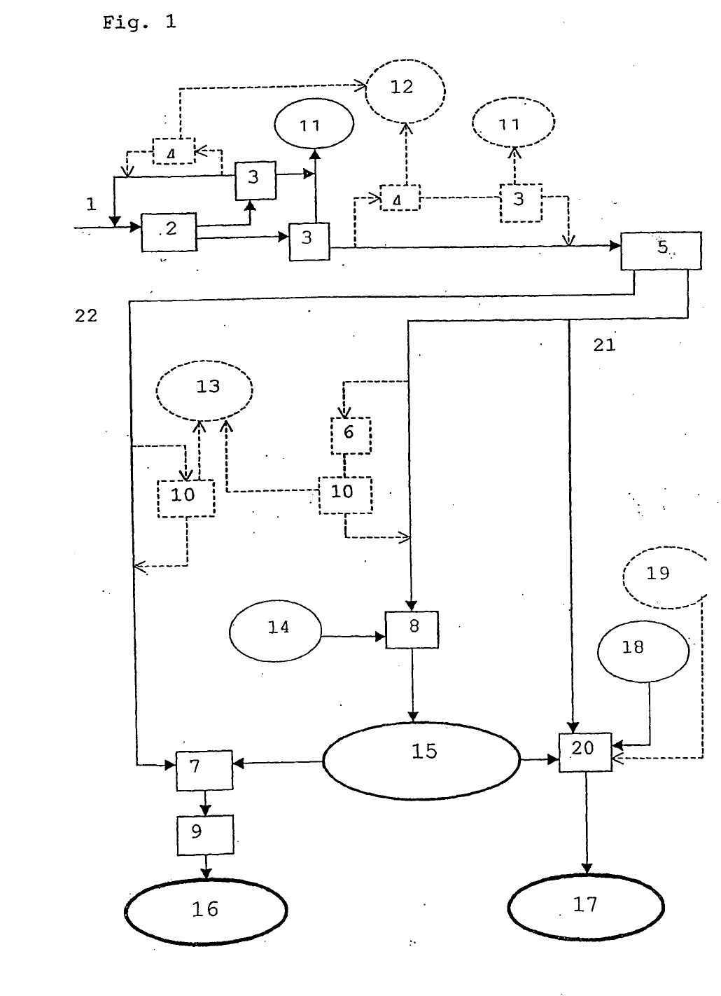

The invention will be explained in more detail below with reference to FIG. 1. Continuous lines show the obligatory procedure and the method steps shown by dashed lines are optional but generally advantageous when using garbage incineration slag. Rectangular symbols represent devices whereas round symbols show substances being removed or added.

### DETAILED DESCRIPTION

Slag 1 from garbage incineration plants or scoria or metallurgical slag is fed to a sifting plant 2. Here, it is separated into a first fraction having particle sizes of greater than 32 mm and a second fraction having particle sizes of less than 32 mm. The first fraction is transported to a separator 4, passing through a magnetic separator 3 to remove iron-containing components 11. The separator 4 is optionally equipped with a blower for removing plastic and paper 12, and this may be advantageous when using slag from garbage incineration plants. After passing through the magnetic separator 3 and the separator 4, the first fraction is comminuted (not shown explicitly in FIG. 1) and returned to the sifting plant 2.

The second fraction having particle sizes of less than 32 mm is likewise transported to a magnetic separator 3 where iron-containing components 11 are removed. Before this second fraction is treated in a further sifting plant 5, it may optionally be fed to a further separator 4 for removing plastic and paper 12 and also to a magnetic separator 3 for removing iron-containing components 11.

In the sifting plant 5, the slag is further separated into superfines 21 having particle sizes of less than 4 mm and gravel 22 having particle sizes of between 4 and 32 mm. The superfines 21 are transported to a pulsed rotary mill 8, optionally having been treated beforehand in a crushing mill 6 and a non-iron-metal separator 10. In the crushing mill 6, the superfines 21 are comminuted to particle sizes of less than 1 mm. In the non-iron-metal separator 10, non-iron metals 13 such as copper or aluminum are removed.

Suitable additives 14 are added to the superfines 21 in the pulsed rotary mill 8, and then mixing and grinding are carried out in order to form hydraulic binders 15. These are ceramic binding systems which are very similar to cement. Depending on the process, binders 15 with varying composition can be produced.

A further part of the superfines 21 may be mixed in section 20 of the plant with a hydraulic binder 15 and also tectosilicates 18 preferably in a mixing ratio of 60% slag 1, 35% binder 15 and 5% tectosilicates 18. Casts and mortars 17 with outstanding properties can thus be produced. Optionally, while correspondingly reducing the amount of slag, fine aluminum powder 19 having particle sizes of less than 0.06 mm may be added in order thus to produce heat insulating cast. In this case, amounts of 35% aluminum powder have proven to be advantageous.

The gravel 22 may likewise optionally be fed to a non-iron-metal separator 10, where once again non-iron metals 13 are removed. In a coating area 7, which may be designed for instance as a coating drum, the slag bodies are coated with a suspension of a hydraulic binder 15. After drying 9, the gravel substitute product is finished.

A method is thus obtained which is suitable for producing casts and mortars and also gravel substitute products based on slag and also based on hydraulic binders which in turn can be obtained from slag. It is also distinguished in particular in that both garbage incineration slag and scoria and metallurgical slag and mixtures thereof may be used, provided that the method steps shown in dashed line in FIG. 1 are also used.

1. A method for the integrated production of casts and mortars (17) based on hydraulic binders (15) and also of gravel substitute (16), characterized in that in a first method step slag (1) is divided into a first and a second fraction with different mean particle sizes, wherein the first fraction having a greater mean particle size is comminuted and returned to the slag (1), and iron-containing components (11) and optionally plastics and paper (12) are removed from the second fraction having a smaller mean particle size, in a second method step the second fraction is subdivided into superfines (21) having the smallest mean particle size and gravel (22) having a greater mean particle size, wherein the superfines (21) are used, after optionally removing non-iron metals (13), to produce hydraulic binders (15), and in a third method step hydraulic binders (15) are used with the superfines (21), tectosilicates (18) and optionally aluminum-containing components (19) to produce casts and mortars (17) and hydraulic binders (15) are used with the gravel (22), after optionally removing non-iron metals (13), to produce gravel substitute (16).

2. The method as claimed in claim 1, characterized in that the slag (1) comes from garbage incineration plants.

3. The method as claimed in claim 1, characterized in that the slag (1) is scoria or metallurgical slag.

4. The method as claimed in claim 1, characterized in that the particle sizes of the first fraction are greater than 32 mm and those of the second fraction are less than 32 mm.

5. The method as claimed claim 4, characterized in that the particle sizes of the superfines (21) are less than 4 mm and those of the gravel (22) are greater than 4 mm.

6. The method as claimed in claim 1, characterized in that the gravel substitute (16) is produced by coating the gravel (22) with hydraulic binders (15).

7. Casts and mortars based on hydraulic binders (15), comprises
55%-65%, garbage incineration slag, metallurgical slag and scoria (1) in any desired mixing ratios but having particle sizes of less than 4 mm,
30%-40%, hydraulic binders (15),
4%-6%, tectosilicates (18), and optionally
3%-5% aluminum powder (19) having particle sizes of less than 0.06 mm.

8. Casts and mortars based on hydraulic binders (15) as claimed in claim 7, characterized in that the hydraulic binder (15) is produced on the basis of slag (1) from garbage incineration plants, scoria or metallurgical slag.

9. A gravel substitute, the gravel particles of which consist of a basic body made of slag (1), characterized in that the basic body is coated with a hydraulic binder (15).

10. A gravel substitute as claimed in claim 9, characterized in that the hydraulic binder (15) is produced on the basis of slag (1) from at least one of garbage incineration plants, scoria and metallurgical slag.

11. A gravel substitute as claimed in claim 10, characterized in that the particle size of the slag is between 4 mm and 32 mm.

12. A gravel substitute as claimed in claim 9, characterized in that the slag (1) comes from one of garbage incineration plants, scoria, and metallurgical slag.
